(19) United States
(12) Patent Application Publication
(10) Pub. No.: US 2006/0212404 A1
(43) Pub. Date: Sep. 21, 2006

(54) Content reproduction apparatus, content reproduction method and program

(76) Inventor: Hirofumi Shimada, Kanagawa (JP)

Correspondence Address: William E. Vaughan;Bell, Boyd & Lloyd LLC, P.O. Box 1135, Chicago, IL, 60690, US

(21) Appl. No.: 11/374,892

(22) Filed: Mar. 13, 2006

(30) Foreign Application Priority Data
Mar. 16, 2005 (JP) P2005-074849

(51) Int. Cl. G06Q 99/00

(52) U.S. Cl. 705/57

(57) ABSTRACT

A content reproduction apparatus and method is disclosed wherein the user can grasp complicated licenses or a relationship of licenses of a plurality of contents intuitively and with certainty from a time line representation. The content reproduction apparatus reproduces a content based on a license for permitting reproduction of the content and includes a content storage section configured to store contents and licenses. A reproduction schedule display section displays a reproduction schedule wherein, where any of the licenses includes a reproduction permission period for a corresponding one of the contents, the reproduction permission period for the content is represented as a time line. A content reproduction section reproduces the content only within the reproduction time period in response to a request from a user, and a content display section displays the reproduction schedule or the content.

### CROSS REFERENCES TO RELATED APPLICATIONS

The present application claims priority to Japanese Patent Application JP 2005-074849 filed in the Japanese Patent Office on Mar. 16, 2005, the entire contents of which is being incorporated herein by reference.

### BACKGROUND

This invention relates to reproduction of a content, and more particularly to a content reproduction apparatus, a content reproduction method and a program which allow visual confirmation of a reproduction permission period of a content.

Recently, a content of images or music can be downloaded simply through a communication network such as the Internet. Such a content as mentioned above is sometimes accompanied by a license for permitting reproduction of the content from the point of view of protection of the copyright. In such an instance, the user would download the content which the user desires to enjoy and acquire the license from a service undertaker who provides the content, and then enjoy the content based on the license.

The license provides restrictions as to the user, reproduction apparatus, reproduction permission period, record retention period and so forth, and the user can utilize the content only within the restrictions. However, the reproduction permission period of a content is usually represented in a time representation (character string) described in the license, and the user cannot readily grasp for what period the content can be reproduced later.

If the user cannot grasp the reproduction permission period or the record retention period of the content, then such a situation occurs that, while the user does not know, the term expires and the user fails to enjoy the content even if the user tries to do so. The user may suffer such a further disadvantage that the user misunderstands that the failure in reproduction of the content arises from a trouble of the apparatus and an operation for confirmation of this is required.

Such problems as described above can be solved by a technique of displaying, with regard to a content whose reproduction permission period is restricted by a license, the period within which or a mechanism by which the reproduction is restricted as disclosed in Japanese Patent Laid-Open No. 2002-325224. With the technique disclosed in Japanese Patent Laid-Open No. 2002-325224, only it is possible for the user to know a remaining period of time before the reproduction permission period expires or an elapsed period of time after the expiration of the reproduction permission period. However, the technique fails to display a relationship of licenses for a plurality of contents at a particular point of time or to display a reproduction permission period of a content which is in a complicated relationship of licenses.

### SUMMARY

It is desirable to provide a content reproduction apparatus, a content reproduction method and a program which are novel and improved in that the user can grasp complicated licenses or a relationship of licenses of a plurality of contents intuitively and with certainty from a time line representation.

According to an embodiment of the present invention, there is provided a content reproduction apparatus which reproduces a content based on a license for permitting reproduction of the content, including a content storage section configured to store contents and licenses, a reproduction schedule display section configured to display a reproduction schedule wherein, where any of the licenses includes a reproduction permission period for a corresponding one of the contents, the reproduction permission period for the content is represented as a time line, a content reproduction section configured to reproduce the content only within the reproduction time period in response to a request from a user, and a content display section configured to display the reproduction schedule or the content. The content reproduction apparatus may be a server, a personal computer, a PDA (Personal Digital Assistant), a portable telephone set or the like.

In the content reproduction apparatus, since the reproduction schedule display section can display a reproduction schedule, the user can intuitively grasp a reproduction permission time period of each content as a time period amount within a predetermined period of time. Further, where a plurality of contents are displayed on the same time axis, the user can grasp a relationship of licenses of a plurality of contents readily. The reproduction schedule display section may display, in the reproduction schedule, in addition to the display of the reproduction permission periods, a parallel display of some other conditions such as, for example, the utilized apparatus or the number of times of check-in and/or check-out.

The reproduction schedule may further include an icon which is an image or a symbol via which the user operates. The icon is movable on the time line in response to an operation of the user such that whether or not reproduction of the content at a point of time at which the icon is positioned is permitted can be decided depending upon whether the icon is active or inactive. Whether the icon is active or inactive may be represented, for example, by the color of the icon such that it is represented in blue where it is active but is represented in black where it is inactive.

In the content reproduction apparatus having the configuration described, whether or not a license is present at a particular point of time, that is, whether or not the content can be reproduced, can be confirmed. Further, where a plurality of contents exist, the user can intuitively grasp a relationship of licenses at a particular point of time. Further, the user can compare the reproduction permission period of a content with the reproduction permission periods of the other contents to make a plan to enjoy the contents such as to determine which one of the contents should be enjoyed first.

The content reproduction apparatus may further include a logical calculation section for calculating, where a plurality of ones of the licenses are applied to any of the contents to be utilized, a logical add of the reproduction permission periods of the licenses to determine a reproduction permission period of the content.

The logical calculation section can display, even where a plurality of licenses are applied to one content, with an overlapping portion of the reproduction permission periods of the licenses taken into consideration, the reproduction schedule such that the overlapping portion looks as if it were a reproduction permission period of one license. By the configuration described, the user can grasp the reproduction permission period of the content readily without performing such a cumbersome operation that all of the plural licenses must be confirmed.

The logical calculation section may further calculate, where the content to be utilized requires the plural licenses, that is, where utilization of the content is permitted only within a period within which the reproduction utilization periods of the plural licenses overlap with each other, a logical AND of the reproduction permission periods of the licenses to determine a reproduction permission period of the content.

In the content reproduction apparatus of the configuration just described, the user can visually grasp a substantial reproduction permission period of a content which can be reproduced only where a plurality licenses overlap with each other. Also it is possible to display a license including a complex of a logical add and a logical AND.

The content reproduction apparatus may further include a display updating section for updating, in response to a variation of a permission range of any of the licenses, the display of the corresponding reproduction permission region.

When a content which is under copyright protection is transferred between digital transmission content protection (DTCP) apparatus on a home network, data of the same content at the same point of time cannot overlap for more than a fixed period of time between such apparatus (synchronous mode). Accordingly, on the sender side, a portion of the content which has been transferred cannot be reproduced, and on the receiver side, only a portion of the content whose transfer is completed can be reproduced. In such transfer, since also a license corresponding to the content moves together with the license, also the range of permission of the license varies during the movement.

In the content reproduction apparatus of the configuration described, even during transfer of a content, the user can visually confirm the reproduction permission period of the content being transferred and perform an operation suitable for the change of the license.

The reproduction schedule display section may further display an extensible reproduction permission period in a different manner of display. The different manner of display may be display of an extensible reproduction permission period in a manner different in terms of the color, mark, bordering or the like of the time line of the reproduction permission period.

The license can be formed such that, for example, it permits free reproduction only of a portion of the content but permits reproduction of the other portion of the content only when a charge is paid. In this instance, at a point of time when the content is acquired, only part of the reproduction permission period is available. Thereafter, if the further license is required, then the reproduction permission period is extended. The extensible reproduction permission period is represented in the different manner as described above, and at a point of time at which the license for the extensible portion is acquired, the entire reproduction permission period is displayed in the same manner. In other words, the reproduction permission portion is displayed in green and the extensible portion is displayed in red, and after the license for the utilization of the extension portion is purchased, the entire portion is displayed in green.

In the content reproduction apparatus of the configuration just described, the user can visually grasp which portion of the acquired content can be reproduced. Further, such a manner of display as described above enhances the will for the purchase of the content. Here, the purchase of one license may make it possible to reproduce the entire extensible content, or the extensible reproduction permission period may be varied in response to the purchase level of a license which is divided in a plurality of levels.

The reproduction permission period may be set by an absolute period of time defined by a starting point of time and an ending point of time or may be set by a relative period of time defined by a sum total of reproduction periods of time.

The absolute period of time represents a period of time according to world standard time and indicates an absolute period of time such as a period of time from 0 a.m. January 1 to 12 p.m. June 30. On the other hand, the relative period of time indicates a total period of time within which the content can be reproduced. Accordingly, the content can be reproduced until after the value counted by a counter provided in the content reproduction apparatus exceeds a preset value by the license. The reproduction schedule display section may additionally display the sum total of the reproduction periods of time at the current point of time.

According to another embodiment of the present invention, there are provided also a program for causing a computer to function as the content reproduction apparatus described above and a content reproduction method for reproducing a content based on a license for permitting reproduction of the content.

Also it is possible to form the components of the content reproduction apparatus individually as apparatus independent of each other.

With the content reproduction apparatus, content reproduction method and program, a complicated license which requires logical adding or logical ANDing or a relationship of licenses of a plurality of contents can be displayed such that the user can grasp the same intuitively and with certainty as a time line represented on the same time axis.

The above and other objects, features and advantages of the present invention will become apparent from the following description and the appended claims, taken in conjunction with the accompanying drawings in which like parts or elements denoted by like reference symbols.

Additional features and advantages are described herein, and will be apparent from, the following Detailed Description and the figures.

### BRIEF DESCRIPTION OF THE FIGURES

FIG. 1 is a diagram illustrating a method of calculating a logical add of reproduction permission periods of a plurality of licenses.

FIG. 2 is a block diagram showing a general configuration of a content reproduction apparatus to which the present invention is applied.

FIG. 3 is a flow chart illustrating a flow of processes for reproduction of a content performed by the content reproduction apparatus of FIG. 2.

FIGS. 4 to 7 are schematic views showing several examples of a reproduction schedule used in the content reproduction apparatus of FIG. 2.

FIGS. 8 to 12 are similar views but showing different examples of the reproduction schedule used in the content reproduction apparatus of FIG. 2.

FIG. 13 is a similar view but illustrating a complicated relationship of licenses.

FIG. 14 is a schematic view showing reproduction schedules used where a content is transferred from a content reproduction apparatus to another content reproduction apparatus.

### DETAILED DESCRIPTION

In the following, preferred embodiments of the present invention are described with reference to the accompanying drawings.

In the embodiments described below, a user would download a content to be enjoyed, acquire a license from a service undertaker who provides the content, and enjoy the content based on the license. During reproduction of the content, the user can know a reproduction permission period of the content, that is, a remaining period of time before the expiration of the term of utilization of the content or an elapsed time period after the term expires. The license here signifies a permit which exists in the form of data or a file in a memory and includes a declaration of a right on a content protected by the copyright. In the embodiments of the present invention, the license includes a description at least of a reproduction permission period.

However, such a reproduction permission period in related art as mentioned above is displayed merely in the form of a character string representing a start point and an end point of reproduction thereof, and it is difficult for the user to intuitively grasp the reproduction permission period. Further, although it is possible also to display such a reproduction permission period simply as an area, a relationship between licenses of a plurality of contents at a particular point of time or a reproduction permission period of a content having a complicated relationship of licenses cannot be displayed in related art.

First, for example, if a reproduction permission period is merely displayed on the same screen while one content is being reproduced, then the user cannot grasp a relationship to licenses of other contents, and much time is required for the user to confirm which contents are valid at a particular point of time.

Second, where a plurality of licenses are applied to one content and have reproduction permission periods which overlap with each other, the period within which the content can be utilized is substantially given by a logical add of the reproduction permission periods of the licenses. Accordingly, the user does not have measures for visually grasping the substantial reproduction permission period and must be performed such complicated operation as to confirm all of the licenses.

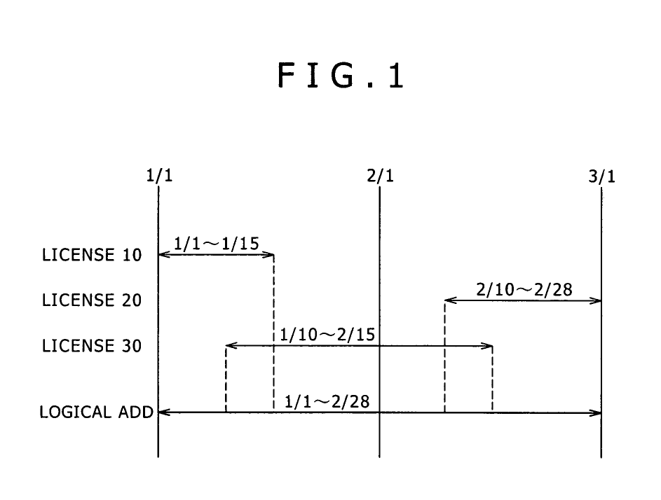

FIG. 1 illustrates a method of calculating a logical add of reproduction permission periods of a plurality of licenses. Referring to FIG. 1, a plurality of licenses 10, 20 and 30 are applied to one content and individually define utilization of the content independently of each other. The license 10 permits reproduction for a period of 1/1 to 1/15 (January 1 to January 15); the license 20 permits reproduction for another period of 2/10 to 2/28 (February 10 to February 28); and the license 30 permits reproduction for a further period of 1/10 to 2/15 (January 10 to February 15). In this instance, the substantial reproduction permission period is a maximum period (1/1 to 2/28) of the three licenses. In related art, the start point and the end point of all right terms are represented in a character string for each license, and the calculation must be performed manually.

Third, where a content protected by the copyright is transferred between DTCP apparatus on a home network, overlapping existence of data between a sender side apparatus (Source) and a receiver side apparatus (Sink) is not permitted for more than a fixed period of time (for example, 60 seconds). For example, where a content for two hours is transferred, usually an isochronous mode is used for the transfer, and in this instance, two hours are fully required for the transfer process. As a result, on the sender side, a portion of the content which has been transferred cannot be reproduced, and on the receiver side, only a portion of the content whose transfer is completed can be reproduced. In the DTCP apparatus described above, the amount of the content or the reproduction permission period of the license varies in response to lapse of time of the transfer.

Originally, also in such a transfer process as described above, each of the apparatus on the sender side and the receiver side should be able to make use of a legal right based on a license regarding data which are not transferred as yet or have been received already. Where the variation of the license in response to the lapse of time described above, that is, the variation of the reproduction permission period, is represented in the form of a character string as in the related art, it is difficult for the user to intuitively grasp on which part of the content the right is actually effective.

In order to solve the subject just described, the embodiments of the present invention have the following characteristics. First, a plurality of contents are displayed on the same time axis to make it possible for the user to grasp a relationship of licenses of a plurality of contents readily and to intuitively grasp a relationship between licenses at a particular point of time, for example, by providing an icon, image or symbol via which the user operates, on a time line. Second, reproduction permission periods of a plurality of licenses are logically added or ANDed so that, even where the licenses have a relationship of complicated conditions, the user can intuitively grasp the relationship of the licenses. Third, a display of a reproduction permission period is updated in response to a variation of the range of permission of a license so that, even during transfer of the content, the user can visually confirm the reproduction permission period of the content being transferred and can perform an operation in response to the variation of the license.

Accordingly, the user can grasp a complicated relationship of licenses or a relationship of licenses of a plurality of contents intuitively and with certainty as a time line. In the following, a content reproduction apparatus according to the embodiments is described.

### First Embodiment

### Content Reproduction Apparatus

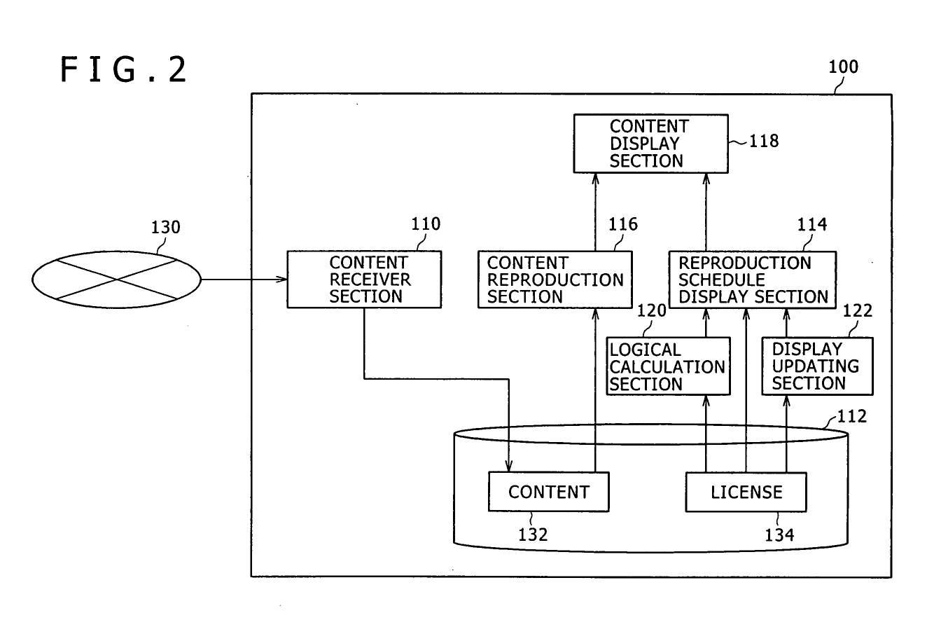

FIG. 2 is a block diagram showing a general configuration of a content reproduction apparatus 100. Referring to FIG. 2, the content reproduction apparatus 100 shown includes a content receiver section 110, a content storage section 112, a reproduction schedule display section 114, a content reproduction section 116, a content display section 118, a logical calculation section 120 and a display updating section 122.

The content receiver section 110 receives a desired content 132, for example, from a server owned by a service undertaker through a communication network 130 such as the Internet. In this instance, where the content to be received is protected by the copyright, also a license 134 for utilizing the content is received together. The content includes dynamic images or music, static still pictures or programs or the like.

The content storage section 112 stores, at least a content 132 and a license 134 received by the content receiver section 110. The content storage section 112 may be formed from a memory such as a HDD or a RAM or a storage medium such as a magnetic disk or an optical disk. The storage of the content 132 includes also storage of the content once into the memory by streaming or the like.

The reproduction schedule display section 114 displays a reproduction schedule if the license 134 stored in the content storage section 112 includes a reproduction permission period of the content 132. The display of the reproduction schedule has an axis of abscissa for a predetermined period, for example, for several months and includes a representation of a reproduction permission period for each content 132 as a time line. The time line is represented by the elapsing direction of the time and the amount of time (length or area of the time line) with reference to the time axis, and the reference time can be represented by an absolute period of time defined by start time and end time or a relative period of time defined by the total of reproduction time periods. The time line is not necessarily represented in one dimension but may be represented in a plurality of dimensions including some other variable or variables.

According to the configuration described, the user can intuitively grasp a reproduction permission period of each content as an amount of time within a predetermined period. Further, where a plurality of contents are represented on the same time axis, the user can readily grasp a relationship of licenses of the contents. Further, the reproduction schedule may include, in addition to the display of the reproduction permission periods, a parallel display of some other conditions such as, for example, the utilized apparatus or the number of times of check-in and/or check-out.

Further, an icon, image or symbol via which the user operates, is provided on a time line of a reproduction schedule displayed on the reproduction schedule display section 114 such that it can be moved in response to an operation of the user. The icon can assume an active state and an inactive state so that the user can decide from the icon whether or not reproduction of the content is permitted at the point of time at which the icon is positioned. In this manner, where a plurality of contents are available, the user can intuitively grasp a relationship of licenses of the contents at a particular point of time. Further, the user can compare the reproduction permission periods of a content with the reproduction permission periods of the other contents to make a plan to enjoy the contents such as to determine which one of the contents should be enjoyed first.

The content reproduction section 116 reproduces, if the user confirms the reproduction permission period of a content on the reproduction schedule display section 114 and tries to reproduce a particular content 132, the content 132 within the reproduction permission period restricted by the license 134.

The content display section 118 is formed, for example, from a display apparatus such as a display panel and displays a content 132 reproduced by the content reproduction section 116 or a reproduction schedule displayed by the reproduction schedule display section 114.

The logical calculation section 120 calculates, where a content 132 has a plurality of licenses 134 applied thereto, that is, where the licenses 134 independent of each other individually represent ranges of permission of the content 132 and permit overlapping utilization of the license 134, a logical add of the reproduction permission periods of the licenses 134 and determines a result of the logical adding as a reproduction permission period of the content 132.

On the other hand, where the content 132 to be utilized requires a plurality of license 134, that is, where the content 132 cannot be utilized unless all of a plurality of predetermined licenses for the content 132 are not satisfied, the logical calculation section 120 calculates a logical AND of the preproduction permission periods of the licenses 134 and determines a result of the logical ANDing as a reproduction permission period. According to the configuration described, the user can visually grasp a substantial reproduction permission period of a content which can be reproduced only when a plurality of licenses overlap with each other or are satisfied simultaneously. Also a display of licenses by a combination of such logical adding and logical ANDing as described above is possible.

The display updating section 122 updates a display of a reproduction permission period in response to variation of the range of permission of a license. As described hereinabove, where a content protected by the copyright is transferred between DTCP apparatus on a home network, overlapping existence of data between a sender side apparatus and a receiver side apparatus is not permitted for more than a fixed period of time. Accordingly, on the sender side, a portion of the content which has been transferred cannot be reproduced, and on the receiver side, only a portion of the content whose transfer is completed can be reproduced. In the DTCP apparatus described above, the amount of the content or the reproduction permission period of the license varies in response to lapse of time of the transfer. By the configuration of the display updating section 122 described above, display of a time line in response to variation particularly of a reproduction permission period of a license can be performed.

Also a program which causes a computer to function as the components of the content reproduction apparatus 100 described above and a storage medium in which the program is stored are provided.

### Second Embodiment

### Content Reproduction Method

Also a content reproduction method for reproducing a content based on a license which permits reproduction of the content is provided.

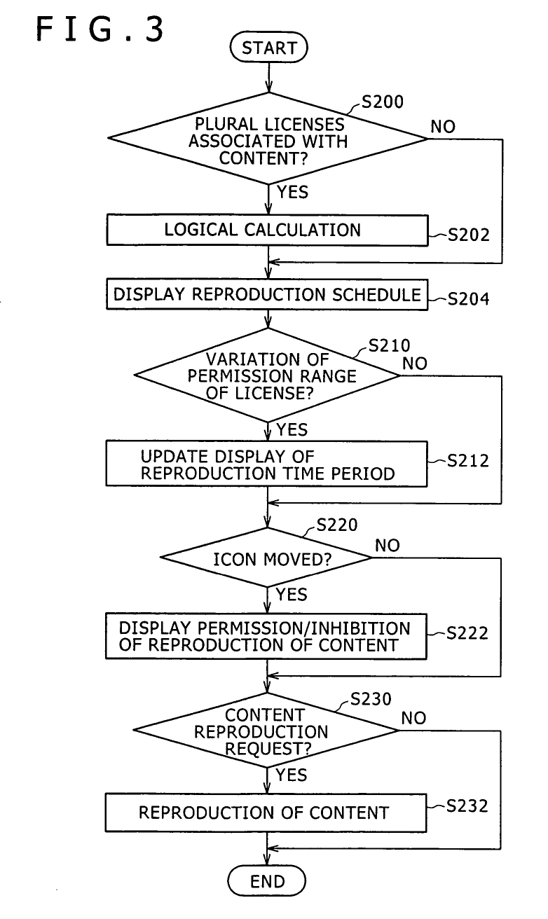

FIG. 3 is a flow chart illustrating a flow of processes when a content is reproduced. Referring to FIG. 3, the content reproduction apparatus 100 first displays a reproduction schedule. Where a plurality of contents are available, the reproduction schedule includes a display of a time line for each of the contents.

The content reproduction apparatus 100 searches a relationship to licenses for each of the contents. Then, if a plurality of contents are associated with one content (step S200), then the content reproduction apparatus 100 logically calculates reproduction permission periods of the licenses and represents a result of the logical calculation as one reproduction permission period on one time line (step S202).

In particular, where a plurality of licenses which define reproduction permission periods independent of each other are applied to a content displayed in the reproduction schedule, the content reproduction apparatus 100 calculates a logical add of the reproduction permission periods of the licenses and determines a result of the logical adding as a reproduction permission period of the content. However, if the content requires simultaneous or overlapping satisfaction of a plurality of licenses, then the content reproduction apparatus 100 calculates a logical AND of the reproduction permission periods of the licenses and determines a result of the logical ANDing as a reproduction permission period of the content.

After the synthesis of the licenses is performed in this manner, the content reproduction apparatus 100 displays the reproduction schedule in which the reproduction permission periods of the individual contents within a predetermined period are represented as time lines (step S204).

If the content reproduction apparatus 100 is a DTCP apparatus on a home network, then the range of permission of a license varies in response to reception of a content from another apparatus or to transmission of a content to another apparatus. Where the range of permission of a license varies in this manner (step S210), the display of the reproduction permission period is updated in response to the variation of the license (step S212).

Here, if the user moves the icon, image or symbol via which the user operates, provided on a time line of the reproduction schedule (step S220), then whether or not reproduction of the content is permitted at the point of time at which the moved icon is positioned is represented by the active or inactive state of the icon (step S222). A plurality of such icons can be provided parallelly to a plurality of contents so that permission/inhibition of reproduction of the contents at the same point of time can be compared.

Thereafter, the content reproduction apparatus 100 detects a reproduction request for a content from the user (step S230). Thus, the content reproduction apparatus 100 reproduces the content only within the reproduction permission period of the license (step S232).

According to the content reproduction method described above, a plurality of licenses or a relationship of licenses of a plurality of contents can be grasped intuitively and with certainty as time lines.

### Third Embodiment

### Reproduction Schedule

In the present embodiment, a reproduction schedule displayed by the content reproduction method described hereinabove is described in detail.

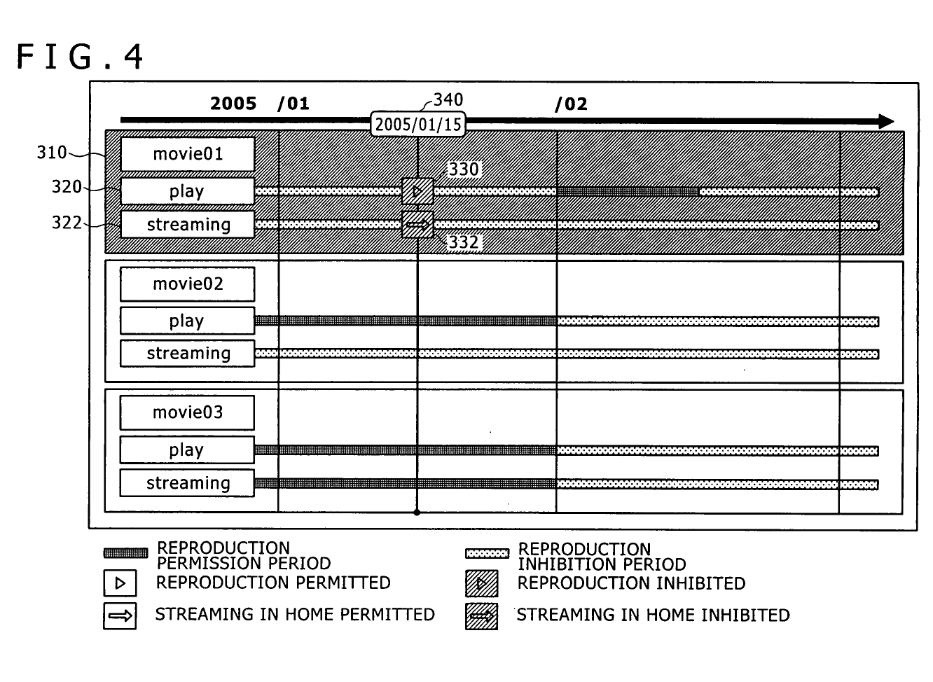

FIG. 4 is a view showing a reproduction schedule according to the present embodiment. Referring to FIG. 4, reproduction permission periods of three contents (movie01, movie02 and movie03) within a predetermined period, that is, within January and February, 2005, are represented as time lines.

In FIG. 4, the content movie01 is selected, and the background of the same is represented in a dense or rather dark color (310). Further, two icons 330 and 332 are displayed corresponding to “play” 320 and “streaming” 322, respectively, on the time line of the selected content movie01. The icons 330 and 332 are movable on the time line in response to an input of a mouse or the like by the user, and the date (or hour) 340 at a point of time when the icons 330 and 332 are positioned is displayed at an upper portion of the screen. Reproduction of the content movie01 is performed for a period from 2/1 (February 1) to 2/15 (February 15) and streaming of the content movie01 is inhibited for the entire period. Therefore, the license at the point of time of 1/15 (January 15) of FIG. 4 exhibits inhibition with regard to “play” 320 and “streaming” 322, and the icons 330 and 332 are displayed inactive.

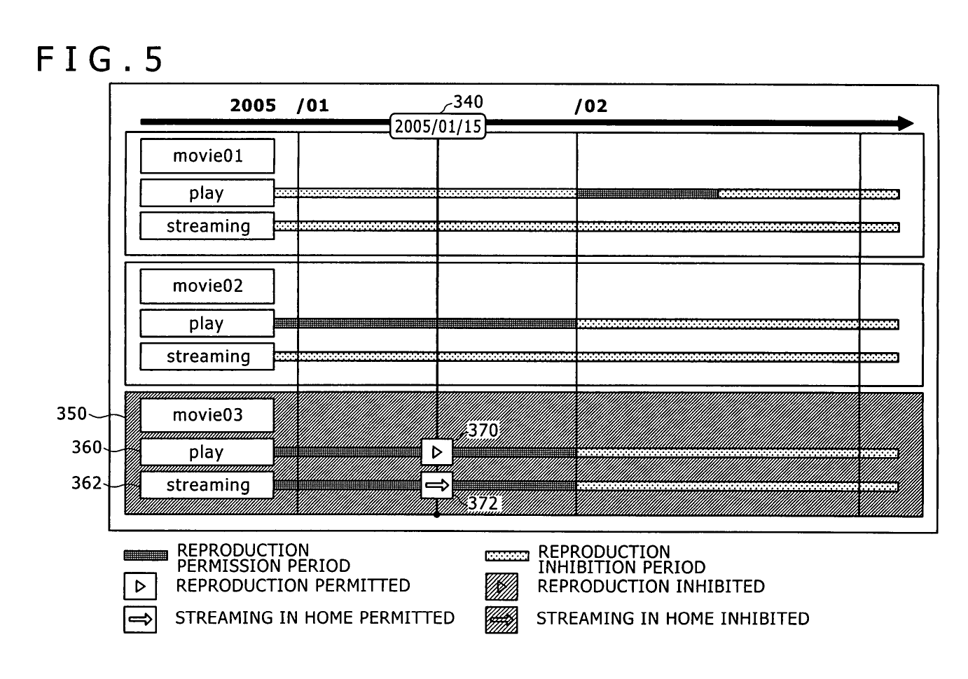

FIG. 5 is a view showing another example of a reproduction schedule according to the present embodiment. While the content movie01 is selected in FIG. 4, the content movie03 is selected in FIG. 5.

Referring to FIG. 5, the user would select the content movie03 by an input through the mouse or the like, and the background of the same is represented in a dense color (350). Further, two icons 370 and 372 are displayed corresponding to “play” 360 and “streaming” 362, respectively, on the time line of the selected content movie03. However, since the positions of the icons 370 and 372 are not moved with respect to the axis of abscissa (time axis), the date 340 at a point of time when the icons 370 and 372 are positioned remains displayed as it is.

Reproduction of the content movie03 is permitted at least for a period from 1/1 (January 1) to 1/31 (January 31) and also streaming of the content movie03 is permitted for the period from 1/1 (January 1) to 1/31 (January 31). Therefore, the license at the point of time of 1/15 (January 15) of FIG. 5 exhibits permission with regard to “play” 360 and “streaming” 362, and the icons 370 and 372 are both rendered active. Consequently, the user can utilize the content movie03 in both of ordinary reproduction and streaming reproduction.

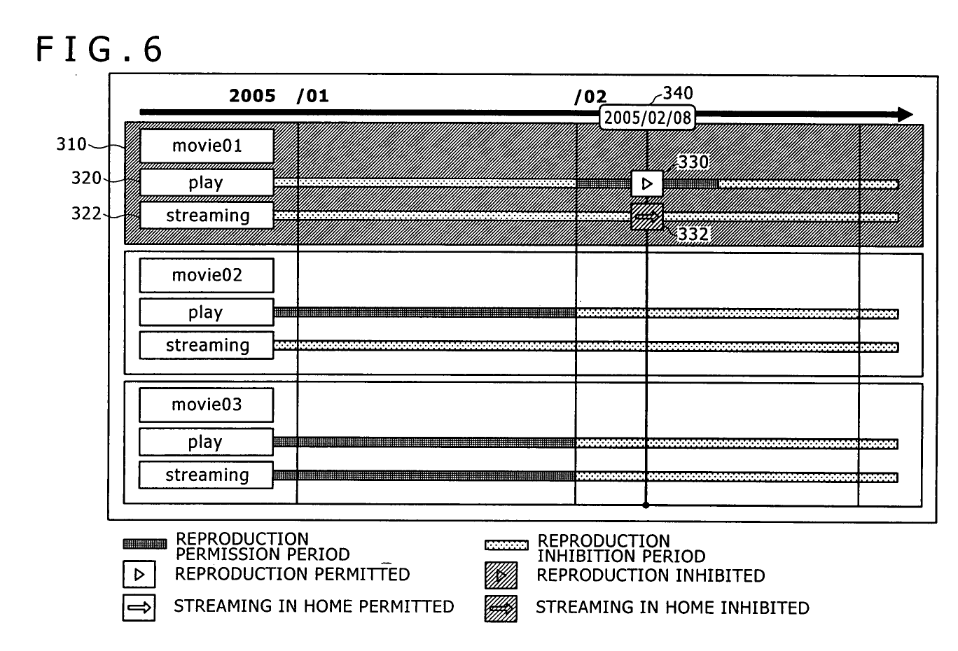

FIG. 6 is a view showing a further example of a reproduction schedule according to the present embodiment. While the content movie03 is selected in FIG. 5, the content movie01 is selected in FIG. 6 similarly as in FIG. 4.

Referring to FIG. 6, the user would select the content movie01 by an input through the mouse or the like, and the background of the same is represented in a dense color (310). Further, two icons 330 and 332 are displayed on the time line of the content movie03. Thus, the icons 330 and 332 are moved in response to an input of the mouse or the like by the user. In response to the movement of the icons 330 and 332, the date 340 at the upper portion of the screen changes to “2005/02/08” (“Feb. 8, 2005”).

Since reproduction of the content movie01 in FIG. 6 is permitted within the period from 2/1 (February 1) to 2/15 (February 15), the icon 330 is placed into an active state. However, since streaming of the content movie01 remains inhibited, the icon 332 remains placed in an inactive state. Accordingly, the user can recognize that the content movie01 can be reproduced at the point of time of the icon 330.

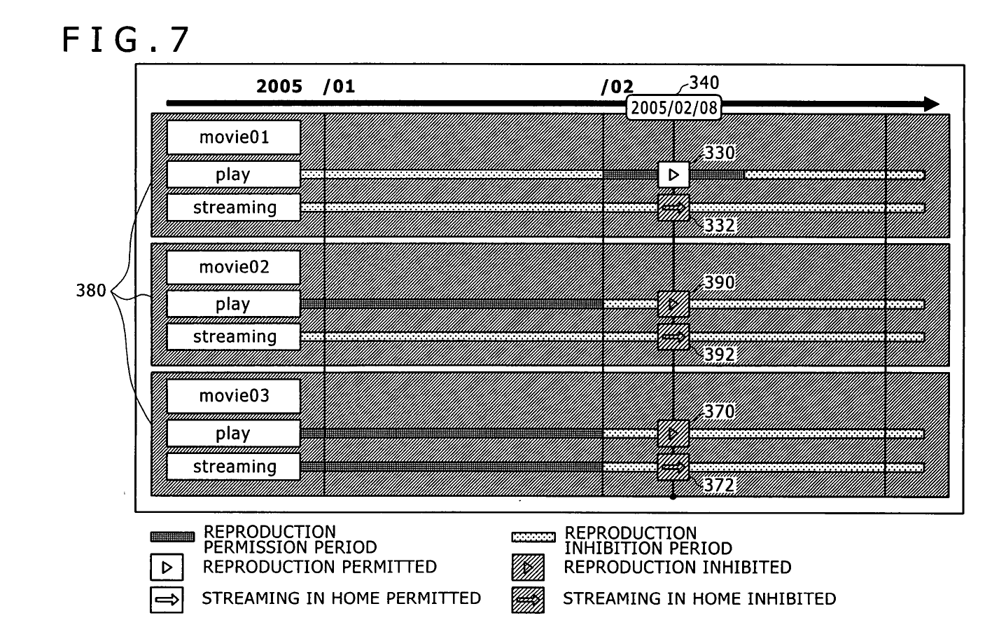

FIG. 7 is a view showing a still further example of a reproduction schedule according to the present embodiment. While only the content movie01 is selected in FIG. 6, all of the contents movie01 to movie03 are selected in FIG. 7.

Referring to FIG. 7, the user would select all of the contents movie01 to movie03, and the background of them is represented in a dense color (380). Then, the icons 330 and 332, 390 and 392, and 370 to 372 are displayed on the time lines of the contents movie01 to movie03, respectively. Since the positions of the icons do not move with respect to the axis of abscissa (time axis), the date 340 at the point of time when the icons are positioned remains displayed as it is at the upper portion of the screen.

In this instance, since the reproduction permission periods of the contents movie01, movie02 and movie03 are 2/1 to 2/15 (February 1 to February 15), 1/1 to 1/31 (January 1 to January 31) and 1/1 to 1/31 (January 1 to January 31) with regard to ordinary reproduction but are inhibited, inhibited and 1/1 to 1/31 (January 1 to January 31) with regard to streaming reproduction, at the point of time of “2005/02/08” (Feb. 8, 2005), only reproduction of the content movie01 is valid and only the icon 330 is rendered active.

In this manner, by selecting a content which can be enjoyed and a particular point of time, the user can instantaneously read a period before the content becomes available or a period within which the content can be utilized actually.

### Fourth Embodiment

### Reproduction Schedule

In the present embodiment, another form of a reproduction schedule displayed by the content reproduction method described above is described in detail.

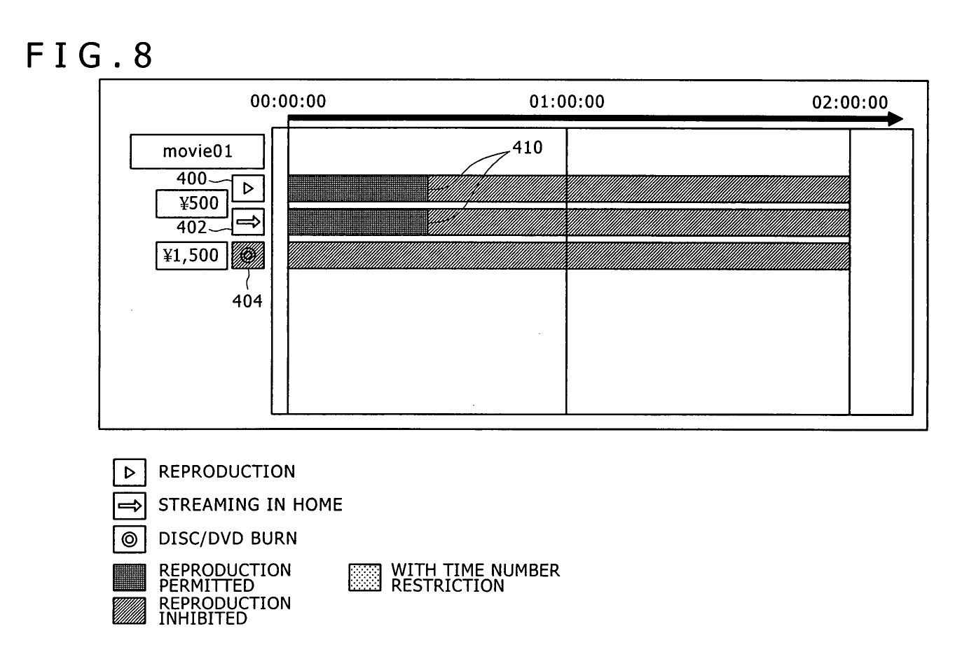

FIG. 8 shows the reproduction schedule according to the present embodiment. The reproduction permission period in the present embodiment is defined by a relative time period given by the sum total of reproduction time periods while the reproduction permission period in the third embodiment described above is defined by an absolute time period. Accordingly, the reproduction permission period (non-reproduction period) is decreased in response to reproduction of the content. The reproduction schedule may include also a display of the sum total of reproduction time periods at the current point of time.

FIG. 8 shows a display of a license in a case wherein an image content for two hours is downloaded through a communication network. It is supposed that the content mentioned is utilized by three processes of reproduction 400, streaming 402 and writing 404 into a storage medium (which may particularly be an optical disk). In the content immediately after downloaded, commercial information reproduced for 30 minutes from the start of the content can be reproduced and streamed free of charge. Accordingly, in the reproduction schedule of FIG. 8, a portion of each of the time lines of the reproduction 400 and the streaming 402 which is for the first 30 minutes is represented as a reproduction permission period 410, and any other portion is represented as a reproduction inhibition period. The reproduction permission period 410 is represented, for example, in green color. The reproduction inhibition period is an extensible reproduction permission period by a license and is displayed in a different form as seen in FIG. 8, for example, in red color.

In the present embodiment, if a license is purchased by payment of 500 yen, then reproduction and streaming of the image content are permitted for a maximum period of time of the content, that is, for two hours.

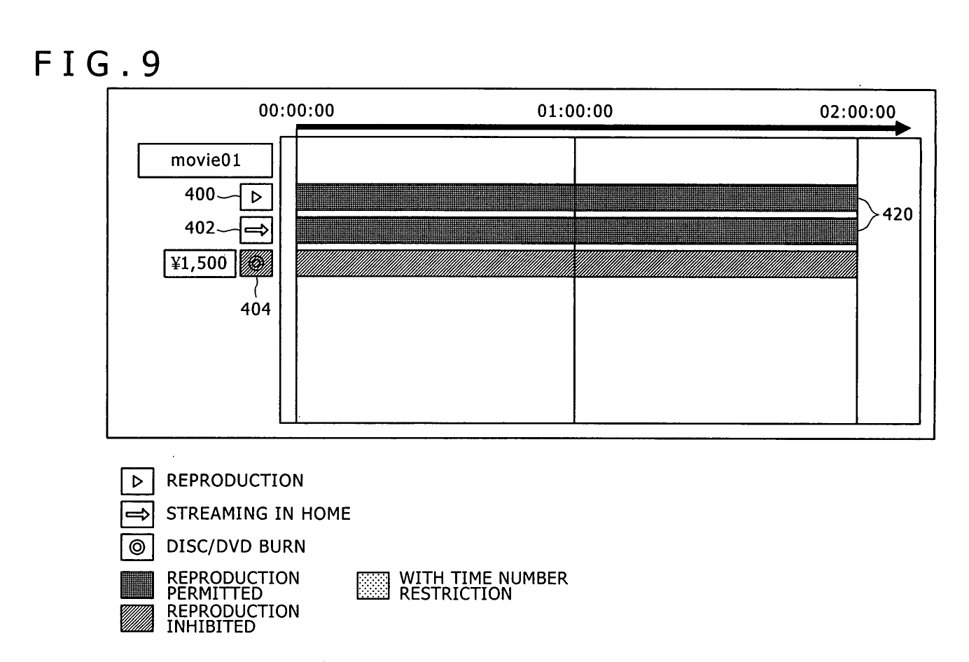

FIG. 9 shows another example of the reproduction schedule according to the present embodiment. If the rights for the utilization of reproduction and streaming are acquired in the state of the reproduction schedule of FIG. 8, then the reproduction schedule changes to such a state as seen in FIG. 9.

In FIG. 9, all of the time lines of the reproduction 400 and the streaming 402 are represented as a reproduction permission period 420, and the user can enjoy the content movie01 fully.

In the present embodiment, if another license is purchased by payment of further 1,500 yen, then writing of the content into a storage medium is permitted.

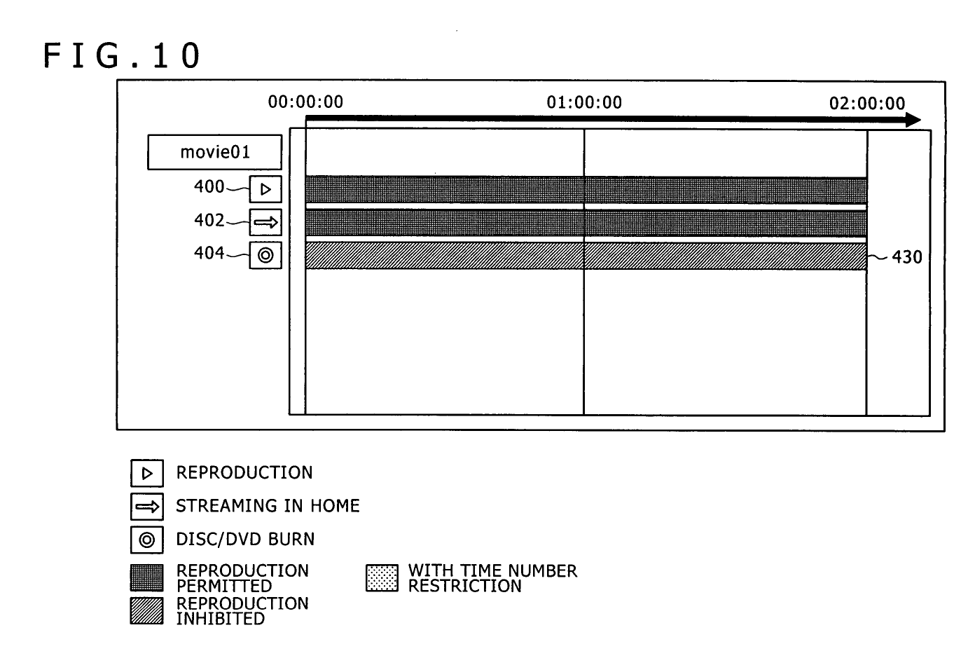

FIG. 10 shows a further example of the reproduction schedule according to the present embodiment. The writing 404 into the recording medium changes to a write-enabled state with a time number restriction (430). Here, writing once on the optical disk is permitted. Then, if writing on the optical disk is executed actually, then a portion of the time line of the license with regard to which the writing is completed changes to a different display such as, for example, to a display in red, which indicates clearly that the utilization thereof is disabled.

Now, a reproduction schedule where a content includes a commercial message is supposed.

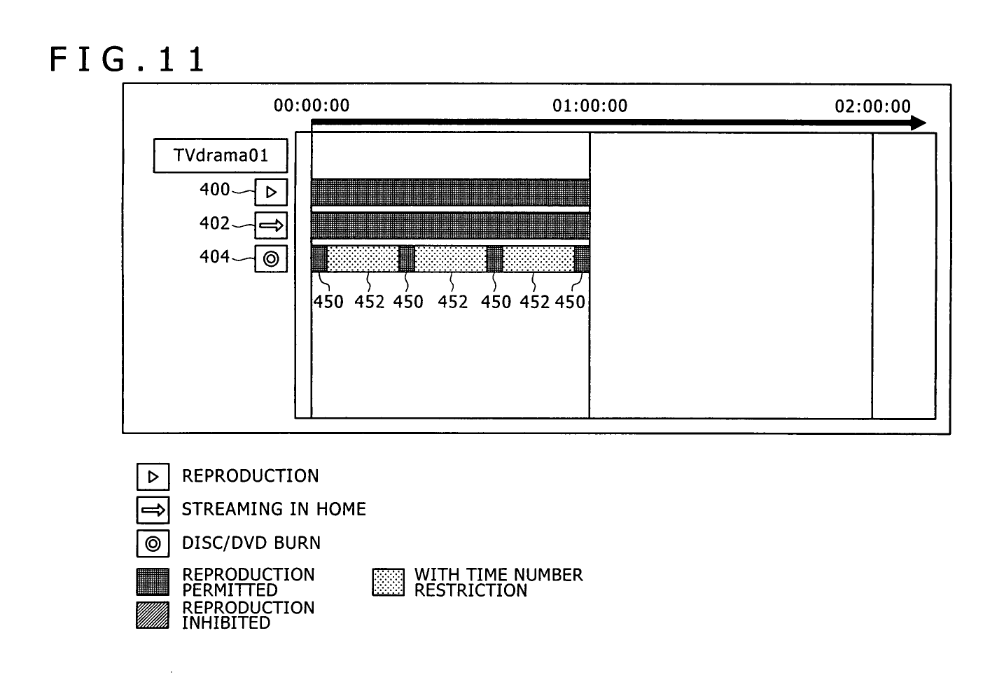

FIG. 11 shows a still further example of the reproduction schedule according to the present embodiment. Referring to FIG. 11, the writing 404 into the storage medium is permitted only once similarly as in the case of FIG. 11. In particular, a commercial region 450 is copy-free and permits limitless writing, but only an actual image region 452 such as the body of a drama makes an object of restriction of writing.

In this instance, if such a content as described above is written, then all of the rights of the license is lost.

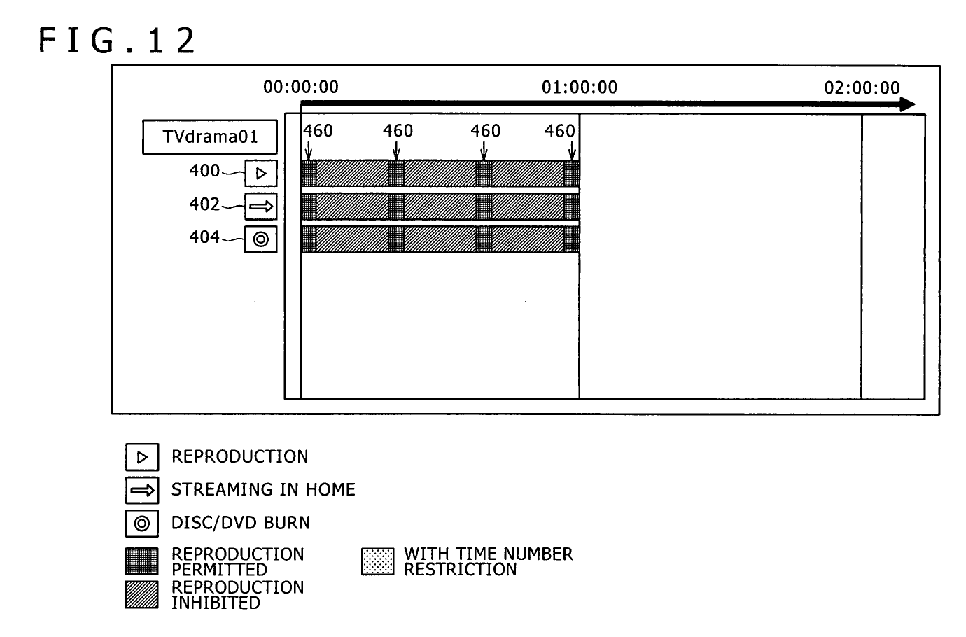

FIG. 12 shows a yet further example of the reproduction schedule according to the present embodiment. The user would perform writing 404 into the recording medium based on the copy-once right. Consequently, the right of the content is transferred to reproduction of the disk, and all of the rights of the license, here, the rights regarding the reproduction 400, streaming 402 and writing 404 on a recording medium, are deleted from the content reproduction apparatus 100 while only commercial regions 460 remain available by the content reproduction apparatus 100.

### Fifth Embodiment

### Reproduction Schedule

As described hereinabove, where a plurality of licenses are applied to a content to be utilized, it is possible to calculate a logical add of reproduction permission periods of the licenses to determine a reproduction permission period of the content or to calculate, where a content to be utilized requires a plurality of licenses, a logical AND of reproduction permission periods of the licenses to determine a reproduction permission period of the content.

Where one content and a plurality of licenses are associated with each other complicatedly, it is possible to display, with an overlapping portion of reproduction permission periods of the licenses taken into consideration, the reproduction schedule such that the overlapping portion looks as if it were a reproduction permission period of one license. In this instance, also it is possible to display a license including a complex of a logical add and a logical AND. Also it is possible to calculate a logical add or a logical AND of licenses including an absolute time period and a relative time period in a mixed state.

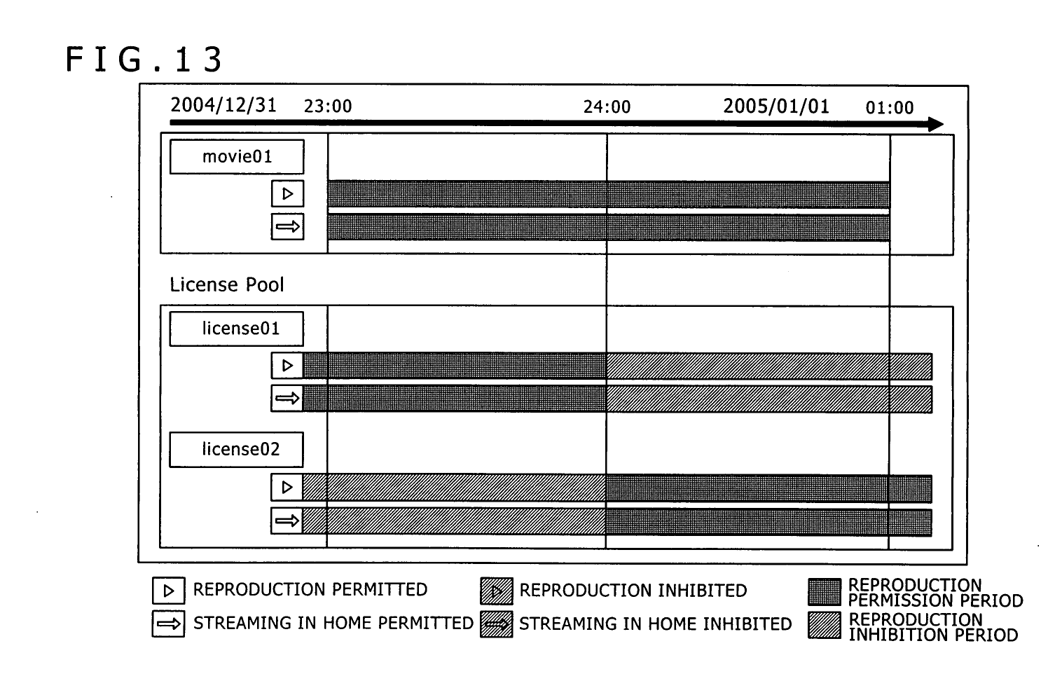

FIG. 13 illustrates such a complicated relationship of licenses as described above. Here, the content movie01 has a reproduction permission period of 23:00 to 01:00 and is accompanied by licenses license01 and licence02 stored in the content storage section.

In this instance, a final reproduction permission period of the content movie01 is determined by calculating a logical add of the reproduction permission periods of the licenses license01 and license02 and a logical AND of a result of the logical adding and the reproduction permission period of the content movie01. As a result, the final reproduction permission period is same as the range of the content movie01 shown at an upper portion of FIG. 13, and also on the screen of the reproduction schedule, only the content movie01 is displayed as the single synthesized reproduction permission period.

While the licenses are applied across a plurality of right ranges in this manner, since they are displayed as a continuous range on the screen, the user can visually grasp the substantial reproduction permission period without performing complicated operation of confirming all of the plural licenses.

### Sixth Embodiment

### Reproduction Schedule

As described hereinabove, when a content which is under copyright protection is transferred between DTCP apparatus on a home network, data of the same content at the same point of time cannot overlap for more than a fixed period of time between such apparatus. Accordingly, on the sender side, a portion of the content which has been transferred cannot be reproduced, and on the receiver side, only a portion of the content whose transfer is completed can be reproduced. In such transfer, since also a license corresponding to the content moves together with the license, also the range of permission of the license varies during the movement.

In the present embodiment, even during transfer of a content, the reproduction permission period of the content being transferred can be visually confirmed and an operation suitable for the change of the license can be performed.

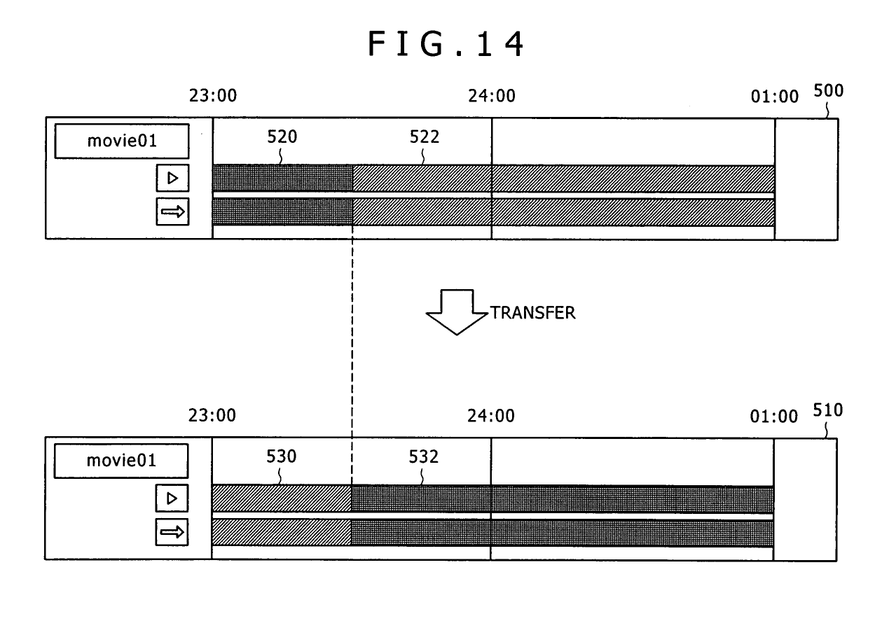

FIG. 14 shows a reproduction schedule where a content is transferred from a content reproduction apparatus 500 to another content reproduction apparatus 510. In the content reproduction apparatus 500 of the sender side, a content 520 which has been transferred already is disabled for reproduction. At this point of time, another content 522 which is not transferred as yet can be utilized by the content reproduction apparatus 500.

On the contrary, on the content reproduction apparatus 510 of the receiver side, a content 530 whose transfer has been completed can be utilized, but another content 532 whose data are not received as yet cannot be utilized as yet.

Such ranges of utilization change in response to lapse of time, and the range of utilization by the content reproduction apparatus 500 on the sender side decreases while the range of utilization by the content reproduction apparatus 510 on the receiver side increases. The reproduction schedule here is different from a download bar in related art in that not a content merely moves but a license of the content moves in a corresponding relationship to the content. Accordingly, also during transfer of a content, a portion of the content can be reproduced only if it is within a valid section on the license time line.

In this manner, even during transfer of a content, the reproduction permission period of the content being transferred can be visually confirmed and an operation suitable for the change of the license can be performed.

While preferred embodiments of the present invention have been described with reference to the accompanying drawings, naturally the present invention is not limited to the specific embodiments. It is apparent that those skilled in the art could make various alterations or modifications within the spirit and scope of the present invention as set forth in the claims, and naturally such alterations and modifications shall fall within the technical scope of the present invention.

For example, while, in the embodiments described above, a final form of representation of a reproduction schedule is vision information, it is otherwise possible to adopt a form of transmission to some other sense such as the sense of touch. In particular, a method of transmitting a right period or an effective point as a pitch of sound outputted from an acoustic apparatus. Also it is possible to use a bar-like substance existing actually as a physical solid representation of a time line such that the sense of touch when the user touches with the surface of the bar-like substance with the hand or the like to transfer a right period or an effective point.

Further, while a final visual representation in the embodiments described above is a one-dimensional straight line, it is otherwise possible to represent the final visual representation in a mathematical space of two or more dimensions. In particular, a method may be used wherein the second and more dimensions are allocated to a right representation different from that on the time axis such that a right representation is provided as a point occupying in the right space in response to a change of the time.

It is to be noted that the steps of the content reproduction method in the present specification need not necessarily be processed in a time series in the order as described in the flow chart and may include processes which are executed in parallel or individually (for example, processes by parallel processing or by an object).

The present invention can be applied to a content reproduction apparatus, a content reproduction method and a program which relate to reproduction of a content and allow the user to visually confirm a reproduction permission period of a content.

While a preferred embodiment of the present invention has been described using specific terms, such description is for illustrative purposes only, and it is to be understood that changes and variations may be made without departing from the spirit or scope of the following claims.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A content reproduction apparatus which reproduces a content based on a license for permitting reproduction of the content, comprising:
a content storage section configured to store contents and licenses;
a reproduction schedule display section configured to display a reproduction schedule wherein, where any of the licenses includes a reproduction permission period for a corresponding one of the contents, the reproduction permission period for the content is represented as a time line;
a content reproduction section configured to reproduce the content only within the reproduction time period in response to a request from a user; and
a content display section configured to display the reproduction schedule or the content.

2. The content reproduction apparatus according to claim 1, wherein the reproduction schedule further includes an icon which is movable on the time line in response to an operation of the user such that whether or not reproduction of the content at a point of time at which the icon is positioned is permitted can be decided depending upon whether the icon is active or inactive.

3. The content reproduction apparatus according to claim 1, further comprising a logical calculation section for calculating, where a plurality of ones of the licenses are applied to any of the contents to be utilized, a logical add of the reproduction permission periods of the licenses to determine a reproduction permission period of the content.

4. The content reproduction apparatus according to claim 3, wherein said logical calculation section further calculates, where the content to be utilized requires the plural licenses, a logical AND of the reproduction permission periods of the licenses to determine a reproduction permission period of the content.

5. The content reproduction apparatus according to claim 1, further comprising a display updating section for updating, in response to a variation of a permission range of any of the licenses, the display of the corresponding reproduction permission region.

6. The content reproduction apparatus according to claim 1, wherein said reproduction schedule display section further displays an extensible reproduction permission period in a different manner of display.

7. The content reproduction apparatus according to claim 1, wherein the reproduction permission period is set by an absolute period of time defined by a starting point of time and an ending point of time.

8. The content reproduction apparatus according to claim 1, wherein the reproduction permission period is set by a relative period of time defined by a sum total of reproduction periods of time.

9. The content reproduction apparatus according to claim 8, wherein said reproduction schedule display section additionally displays the sum total of the reproduction periods of time at the current point of time.

10. A program for reproducing a content based on a license for permitting reproduction of the content, said program causing a computer to function as:
a content storage section configured to store contents and licenses;
a reproduction schedule display section configured to display a reproduction schedule wherein, where any of the licenses includes a reproduction permission period for a corresponding one of the contents, the reproduction permission period for the content is represented as a time line;
a content reproduction section configured to reproduce the content only within the reproduction time period in response to a request from a user; and
a content display section configured to display the reproduction schedule or the content.

11. A content reproduction method for reproducing a content based on a license for permitting reproduction of the content, said content reproduction method being executed by a computer, said content reproduction method comprising the steps of:
displaying a reproduction schedule wherein, where any of licenses includes a reproduction permission period for a corresponding one of contents, the reproduction permission period for the content is represented as a time line; and
reproducing the content only within the reproduction time period in response to a request from a user.
